(19) United States
(12) Patent Application Publication
(10) Pub. No.: US 2009/0047451 A1
(43) Pub. Date: Feb. 19, 2009

(54) Molded mat, and a method and a mold for making the mat

(76) Inventors: Philip C. Huss, Rockvale, TN (US); Michael E. Franklin, Nashville, TN (US); Robert C. Lynch, Fuquay Varina, NC (US)

Correspondence Address: CLARK & BRODY, 1090 VERMONT AVENUE, NW, SUITE 250, WASHINGTON, DC, 20005, US

(21) Appl. No.: 11/889,873

(22) Filed: Aug. 17, 2007

(51) Int. Cl. F16B 5/07; B22D 7/10; B29C 39/00; B32B 3/06

(52) U.S. Cl. 428/33; 249/204; 264/299; 428/99

(57) ABSTRACT

A molded mat comprises male and female connectors that are configured to exhibit improved connectivity when engaged with connectors of an adjacent mat. A method of molding the mat includes providing specially placed vents in the mold to form the increased density portions of the mat. The mat can also include additional recesses formed in the underside of the mat so that the mat can be cut to a smaller size without losing its ability to connect with other mats.

### FIELD OF THE INVENTION

The present invention is directed to a molded mat that has structure to better connect with adjacent mats, including the ability to modify its size without losing it connectivity and the use of side ramps to terminate the mat on its ends. The molded mat is made using a mold that is configured to increase the density of the mat portions in the connector portions of the mat to enhance connectivity.

### BACKGROUND ART

In the prior art, the use of molded mats, e.g., polyurethane foam molded mats, in industrial and commercial applications is well known. These foam mats are advantageous because of the resiliency and cushioned support that the foam provides for workers when the workers are engaging in tasks that require an excessive amount of standing in a given location.

The method of making polyurethane foam mats is well known. Typically, a polyurethane liquid composition is poured in the bottom of a mold, with the mold angled to facilitate spreading of the liquid composition throughout the mold. The polyurethane composition generally combines a polyether such as polypropylene gycol with a diisocyanate in the presence of water and a catalyst. The mold is then closed so that the polyurethane foam can form, with water reacting with the isocyanate groups to cause cross linking and production of foam-causing carbon dioxide. Once the requisite amount of time has elapsed, the mat is removed from the mold for final curing. Mold release compounds or other mold release components can also be used as part of the molding process.

These mats have been molded in a variety of configurations to facilitate linking the mats together to provide a greater coverage of area with the mats. In one mode, the mats are molded with straight edges, and glued together to form a larger size mat. The problem with this approach is that the joint formed by butting two faces of adjacent mats together does not always withstand the rigors placed on the mats, and the formed seams tend to separate and the mats become displaced from each other.

A second approach for linking mats together is the use of connectors molded or otherwise formed in the mats. U.S. Pat. No. 4,018,025 to Collette is an example of once such mat, wherein connectors are formed along the periphery of the mat to connect with adjacent mats. However, these types of connections are also not without their problems since the connector portions of the mat that extend from the mat body can either break off or tear so that the connection to an adjacent mat can be compromised.

In light of the drawbacks noted above in prior art mat designs, a need exists to provide improved foam mat construction, particularly in the area of how the mats are constructed to form even greater mat areas. The present invention responds to this need with an improved mat construction as well as a method of making the mats and the mold that is used in the method of making.

### SUMMARY OF THE INVENTION

Accordingly, it is one object of the invention to provide an improved molded mat, including one with optional side ramp mats that interface with the mat to terminate the mat edges cleanly.

Another object of the invention is a molded mat and/or side ramp mats that has the ability to be modified in width and length without sacrificing its ability to connect to other mats.

Yet another object of the invention is a method of making the molded mat, wherein the connection portions of the mat are enhanced with higher density to improve the mat's connection capability and endurance.

One other object of the invention is a mold that is used as part of the method of making the molded mat, the mold specifically configured to assist in forming improved connection portions of the mat.

Other objects and advantages will be come apparent as a description of the invention proceeds.

In satisfaction of the foregoing objects and advantages, the invention, in one mode, comprises a molded mat that includes a mat body having a peripheral edge and at least one set of outer male connectors along at least a portion of the peripheral edge. At least one set of female connectors is provided along at least another portion of the peripheral edge. Preferably, the portion of the peripheral edge containing the outer male connector includes a step, with each outer male connector extending from the step.

Each female connector comprises a recess formed in an underside of the mat near the peripheral edge, with adjacent recesses separated by an inner male connector. An end face of the inner male connector is spaced from the peripheral edge of the mat body to create another step that interfaces with the step associated with the outer male connectors. The outer male connectors are adapted to engage recesses of female connectors of an adjacent mat and the recesses of each female connector are adapted to receive inner male connectors of an adjacent mat to link one or more adjacent mats together.

The mat may be square or rectangular with the outer male connectors being arranged along two sides of the mat, and the female connectors being arranged along the remaining two sides. The outer and inner male connectors can have a trapezoidal shape, and the recesses of the female connectors have a corresponding trapezoidal shape. A peripheral portion of each of the inner male connectors can have higher density than a central portion of each of the inner male connectors when practicing the method of the invention.

In another aspect of the invention, the mat along sides thereof can be made up of a plurality of unit lengths and/or unit widths, each unit length defined by a line extending perpendicular to one side of the mat and across a width of the mat, with each unit width defined by a line extending perpendicular to another side of the mat and across the length of the mat. In this embodiment, the underside of the mat can have a groove that runs along each unit length line and each unit width line. The underside of the mat would include a first plurality of underside recesses along the unit length line and a respective unit length groove and a second plurality of underside recesses along the unit width line and a respective unit width groove, wherein cutting the mat along one of the unit length line or unit width line creates a mat of reduced length or width to form underside female connectors. These connectors each comprise the underside recess along the cut unit length line or unit width line and underside inner male connectors between each underside recess. Each underside inner male connector has an end face spaced from a cut edge of the mat to link. The underside female connectors created by the cut unit length or unit width line are adapted to connect to outer male connectors of an adjacent mat.

In another aspect of the invention, the mat can be combined with at least first and second side ramp mats. The first side ramp mat further comprises a plurality of outer male ramp connectors adapted to engage female connectors on the mat, the first side ramp having a tapered cross section, with a thicker portion of the mat coinciding with the outer male ramp connectors. The second side ramp mat can comprise a plurality of female ramp connectors adapted to engage outer male connectors on the mat, the second side ramp also having a tapered cross section, with a thicker portion of the mat coinciding with the female ramp connectors. One end of each of the first and second side ramps can have a female corner end connector with the other end of each of the first and second side ramps having a male end connector. The male end connector of the first and second side ramps is adapted to engage a female corner end connector on an adjacent first or second side ramp for linking side ramps that are each connected to a different side of the mat.

The first and second side ramps can be cut similar to the mat described above to match the mat when it is altered along one of the unit length or unit width lines. Here, each of the first and second side ramps can have a ramp length made up of unit ramp lengths that correspond to either unit lengths or unit widths of the mat. Each of the first and second side ramps having a ramp recess in an underside of the ramp at each unit ramp length, wherein cutting at the unit ramp length exposes the recess for connection to a male end connector of an axially aligned first or second side ramp. The female corner end connector on each end of each of the first and second side ramps can comprise a recess in an underside of the female corner end connector, an upper surface of the female corner end connector having one portion angled to match a taper of the side ramp having the female corner end connector as a part thereof, with the other portion angled to match a taper of an adjacent and perpendicularly attached side ramp.

Another aspect of the invention is a method of molding a mat. The method entails the steps of providing a mold comprising a bottom mold half and a top mold half. The bottom mold half has at least one outer male connector forming side, the at least one outer male connector forming side including a first step and a plurality of first recesses to receive a mat molding composition. The top mold half has at least one female connector forming side, the female connector forming side including a second step and a plurality of second recesses to receive the mat molding composition. The top mold half includes at least one vent hole in communication with each second recess to allow air and excess mat composition to exit the top mold half during a molding process to increase a density of the mat composition to be formed in each second recess of the female connector that is in a vicinity of the at least one vent hole during the molding process. The mat composition is poured into the bottom mold half and the bottom mold half is mated with the top mold half to mold the mat. Once the molding is complete, the molded mat is removed from the mold. Preferably, the mold bottom half has two sides forming outer male connectors and the mold top half has two sides forming female connectors with each of the first and second recesses being provided with a trapezoidal shape. The top mold half can be provided with the vent hole near each outer corner of each trapezoidal shaped second recess.

The invention also comprises a mold for making molded mats. The mold includes a bottom mold half and a top mold half, the bottom mold half having at least one outer male connector forming side, the outer male connector forming side including a first step and a plurality of first recesses adapted to receive a mat composition for molding. The top mold half has at least one female connector forming side, the female connector forming side including a second step and a plurality of second recesses, the second step and second recess adapted to receive the mat composition. The top mold half includes at least one vent hole in communication with each second recess to allow air and excess foaming composition to exit the mold during a molding process to provide the increased density mentioned above. The recesses and protrusions in the mold can have a trapezoidal shape, with the top mold half containing a pair of vent holes, each vent hole positioned in a respective outer corner of each of the trapezoidal shaped second recesses. Rather than only two sides configured to form connectors on the mat, the mold bottom half can have two sides forming outer male connectors and the mold top half can have two sides forming female connectors.

The mat and molding process preferably employ a polyurethane foam composition for mat making, but other compositions that can be molded to form the mat can be employed.

### BRIEF DESCRIPTION OF THE DRAWINGS

FIG. 1 is a perspective view of a top of a polyurethane foam mat according to a first embodiment of the invention.

FIG. 2 is a perspective view of a bottom of the mat of FIG. 1.

FIG. 3 is an enlarged view of a portion of the mat of FIG. 1 identified by III.

FIG. 4 is a top view of a portion of the mat of FIG. 1.

FIG. 5 is a cross sectional view along the line V-V of FIG. 4.

FIG. 6 is a cross sectional view along the line VI-VI of FIG. 4.

FIG. 7 is a partial top view of the bottom of the mat of FIG. 1.

FIG. 8 is a cross sectional view along the line VIII-VIII of FIG. 7.

FIG. 9 is an enlarged view of the region identified in FIG. 7 as IX-IX.

FIG. 10 is a cross sectional view of the outer male connector of one mat engaged with the female connector of an adjacent mat.

FIG. 11 is a perspective view of the underside of a mat showing another embodiment of the invention.

FIG. 12 is a perspective view of the top of one embodiment of a side ramp for terminating an edge of the mat of FIG. 1.

FIG. 13 is a perspective view of an underside of the side ramp of FIG. 12.

FIG. 14A is a cross sectional view along the line XIVA of FIG. 13.

FIG. 14B is a cross sectional view along the line XIVB of FIG. 13.

FIG. 15 is a perspective view of the top of another type of side ramp.

FIG. 16 is a perspective view of the bottom of the side ramp of FIG. 15.

FIG. 17 is a partial perspective view of top and bottom halves of an exemplary mold for making the inventive mat.

FIG. 18 is a different partial perspective view of the mold of FIG. 17.

### DETAILED DESCRIPTION OF THE PREFERRED EMBODIMENTS

The present invention offers significant improvements in the field of molded mats, particularly polyurethane foam molded mats, in that the mats are provided with improved connections for linking other mats together to form a larger mat area. These improvements are achieved using the particular configuration of the connections as well as by the method of making the mat and the mold used for its making. The mat of the invention also has the capability to modify its length and/or width without losing its ability to connect to other mats. Another advantage of the invention is the use of side ramp mats that allow the edges of the mat to be cleanly terminated and provided a ramp surface from a floor to the mat top surface.

Yet another advantage of the mat is the use of connectors that have portions of increased density. This increased density portions are derived from the manner in which the mat is made, and improves the mat's connection capability.

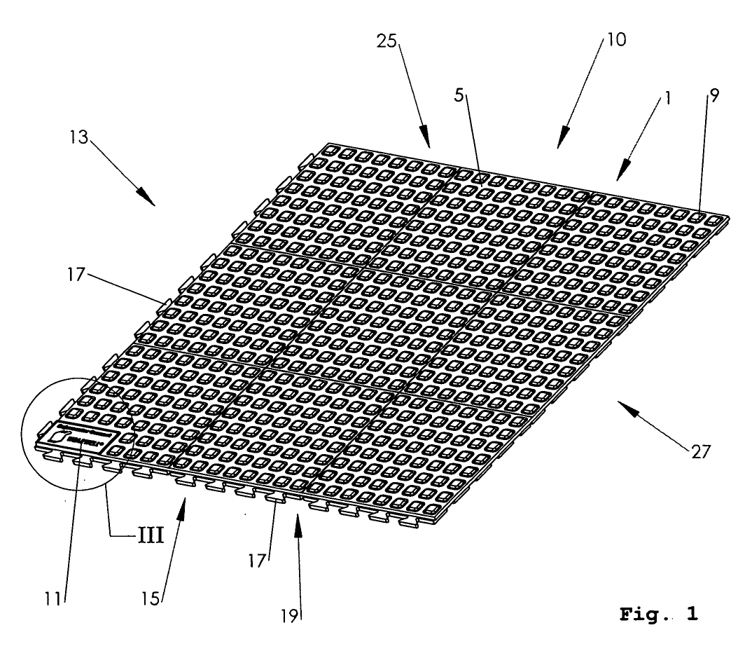

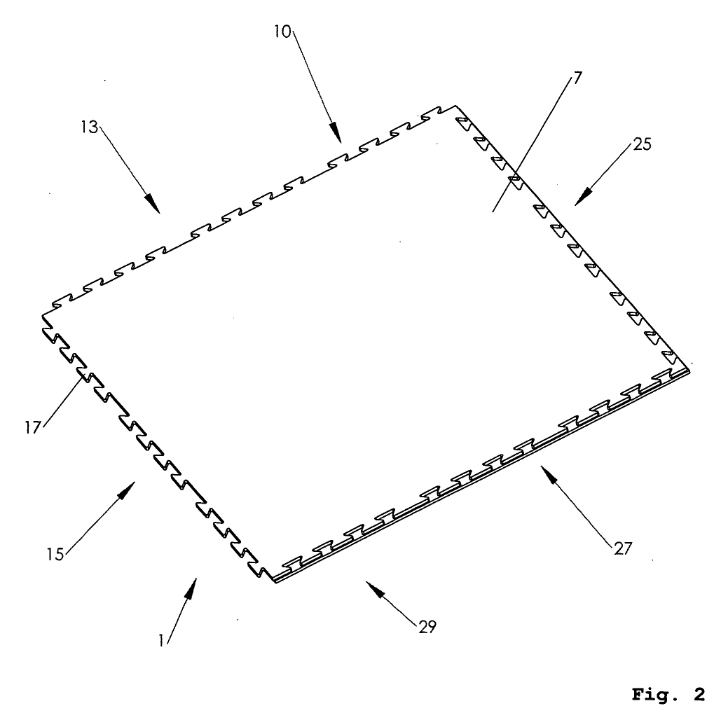

FIGS. 1 and 2 show one embodiment of the inventive mat as a polyurethane foam molded mat, with the mat designated by the reference numeral 10. The mat 10 includes a mat body 1 that has a top surface 5 and a bottom surface 7. The embodiment of FIGS. 1 and 2 shows a top surface that has a plurality of evenly distributed raised portions 9 and a logo portion 11. The configuration of the top surface 5 and inclusion of a logo is just one type of surface configuration that can be used. Other surface configurations as well as either a different logo or no logo at all can be utilized as part of the mat.

Referring to FIGS. 1-6 now, the mat 10 is shown with two sides 13 and 15, each having outer male connectors 17 extending along an edge 19 of each side. The edge 19 has a step 21, and each outer male connector 17 extends from the step 21. The step 21, as will be described below, enhances the strength of the connection with an adjacent mat since the joint between two adjacent mats does not align vertically at the narrow portion 23 of the outer male connector 17.

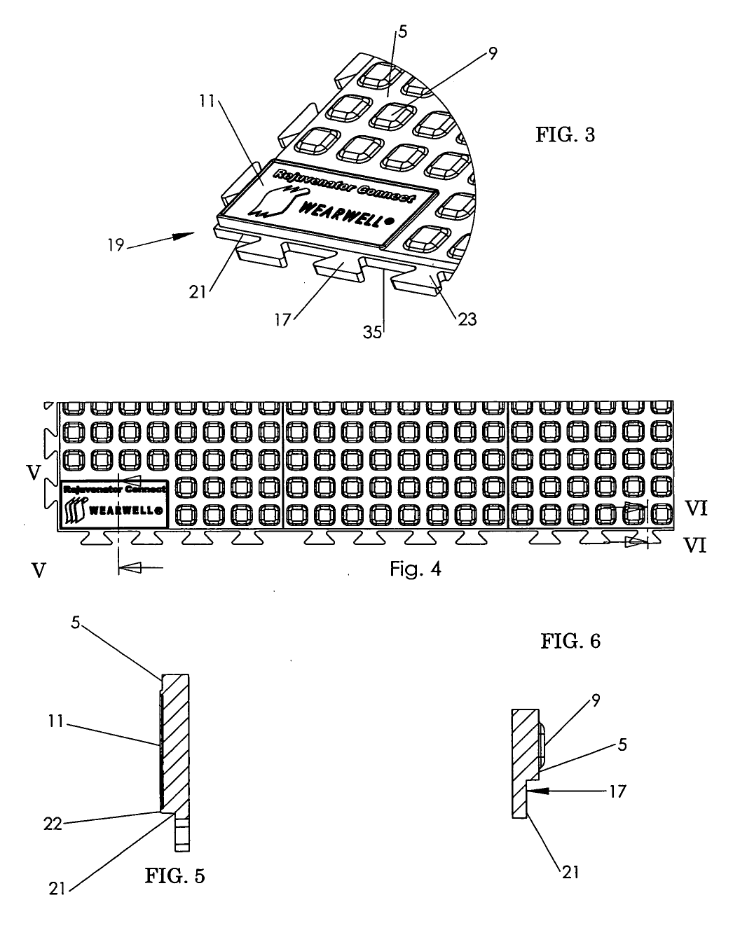

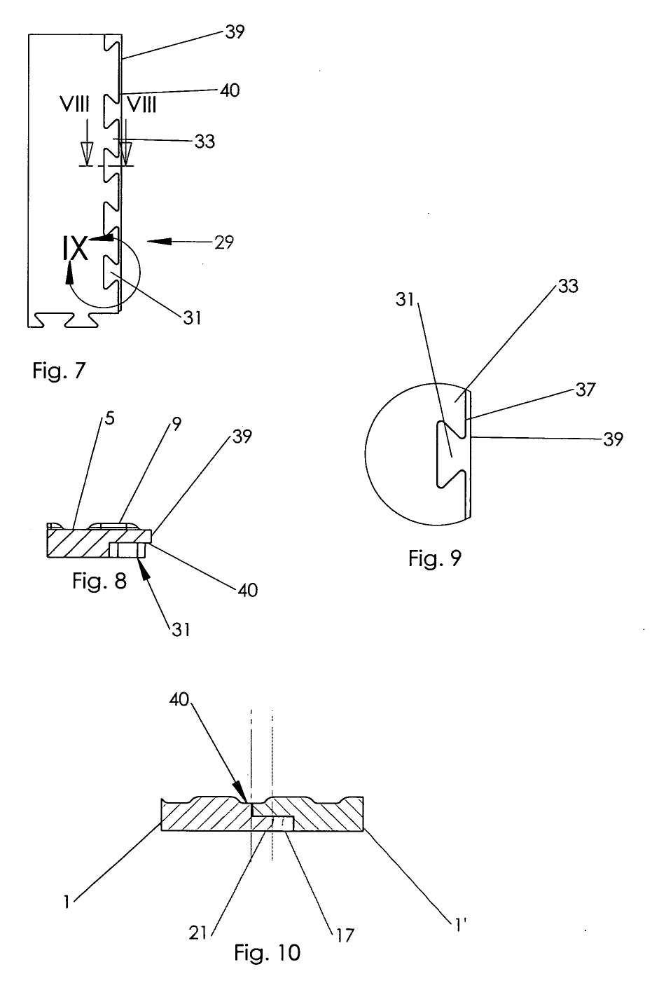

Referring now to FIGS. 1, 2, and 7-9, the other two sides of the mat 10 are designated by reference numerals 25 and 27. These sides have female connectors generally identified by the reference numeral 29. Each connector 29 has a recess 31, which is sized to receive the outer male connector 17. Between each recess 31 is an inner male connector 33, which is complementary to the recess 35 formed between each outer male connector 17, see FIGS. 3 and 4.

Each of the inner male connectors 33 has an end face 37, see FIG. 9, which is spaced from the outside end face 39 of the side 27 containing the female connectors 29. This spacing creates a step 40, see FIG. 8, which is designed to engage the step 21 associated with the outer male connectors of an adjacent mat, when the two are linked together. This is best seen in FIG. 10, wherein the outer male connector 17 shown as a portion of mat body 1 engages the recess (not shown) of a portion of an adjacent mat body 1′. The distance “x” represents the contact between the step 21 of mat body 1 and the step 40 of the mat body 1′. From this, it can be seen that an outside end face of the side of mat 1′ (39 in FIG. 9) would not align with end face 22 of the mat 1 (see FIG. 5), and this misalignment enhances the connection between the two mats 1 and 1′.

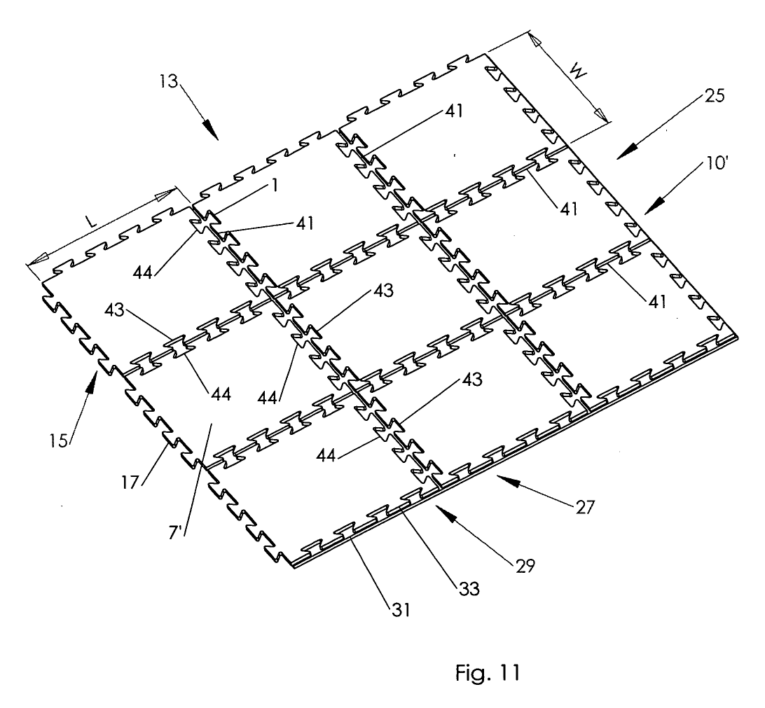

Another aspect of the invention is shown in FIG. 11 by mat 10′. Here, the mat 10′ has a mat bottom 7′ formed with a number of recesses and grooves so that the mat can be used in different lengths/widths but still retain its ability to connect with adjacent mats. In this embodiment, the mat 10′ is formed with three multiples of a unit length L and a unit width W. It should be understood that the number of multiples may vary depending on the shape of the mat. For example, the mat could be rectangular in shape with three unit lengths and two unit widths. For each unit length, the bottom 7′ of the mat has a groove 41 that extends the width of the mat. Also associated with the groove 41 is a plurality of opposing recesses 43 and 44 Each recess is sized in shape to complement an outer male connector 17, with adjacent recesses 43 on each side of the groove 41 forming an underside male connector 45, which is adapted to engage the recess between outer male connectors of another mat.

The groove 41 is sized in width so that when the mat 10′ is cut along a centerline of the groove, a female connector is formed on either side of the groove 41. When the cut is made along the groove 41 of FIG. 11 that coincides with the identified unit length L, the mat 10′ would have a length of L and width of 3 W. Female connectors would be formed along the side formed by the cut and the remainder of side 27, with male connectors remaining on the side 13 of length L and side 15 of width 3 W. The presence of the grooves 41 allows the mat to be cut into different lengths and or widths to accommodate a mat installation in a given location.

In FIG. 11, a groove 41 is shown at each unit length and unit width. With the two grooves extending the width of the mat and two grooves extending the length of the mat, a mat initially having a dimension of 3 L×3 W can be cut to form mat sizes of 1 W×1 L, 1 W×2 L, 1 W×3 L, 2 W×1 L, 2 W×2 L, 2 W×3 L, 3 W×1 L, and 3 W×2 L.

While FIG. 11 shows opposing recesses 43 and 44, only one set of recesses, e.g., recesses 44 along the groove 41 could be formed. In this mode, only certain sections of the cut mat would be able to be used for connection along the groove.

It should be noted in the embodiment of FIGS. 1 and 11 that along side 13 at the unit length location, the recess between the outer male connectors 17 is made wider to accommodate the cutting of the mat into smaller segments. Similarly, on the side 27 having the female connectors 29, the inner male connector 33 is made wider for the same purpose. If there was no intent to have the capability to adjust the size of the mat using recesses and grooves in the bottom of the mat, the outer male connectors and female connectors could be made uniform along the entire side of the mat. It should also be understood that while the mat of FIG. 11 with its ability to have its length or width changed without losing its ability to connect to other outer male connectors, the configuration of the female connectors and male connectors could vary. That is, female connectors and male connectors without the increased density characteristic discussed below or the steps discussed above could be employed to make not only the connectors for the peripheral edges of the mat but also the female connectors formed in the underside of the mat.

While the mat 10 is shown in a square configuration, it should be understood that other configurations such a rectangular or any other shape that would permit the linking with another mat using at least one side with the outer male connectors and at least one side with the female connectors. For example, the mat may be designed for a corner, wherein only one side of outer male connectors and one side of female connectors may be necessary to connect to other mats. To go along a wall, the mat may only need three sides of connectors. Also, while trapezoid shapes are used for the inner and outer male connectors and the recesses, other shapes could be employed as well, e.g., oval shapes, square shapes and the like.

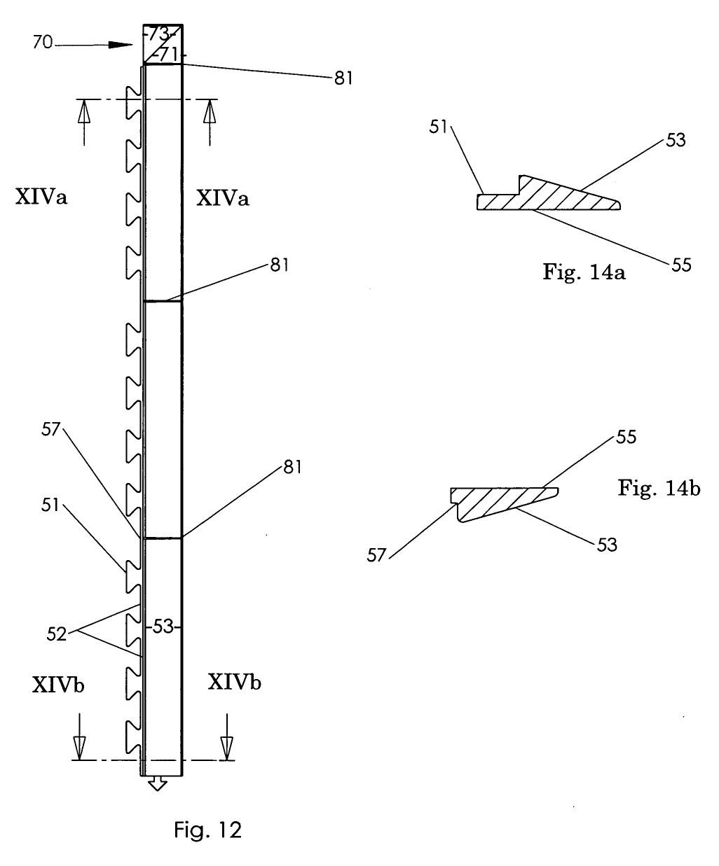

Another aspect of the invention is the use of one or more tapered side ramp mats to terminate the mat when no further connection is needed or desired. Figures 12-16 show two types of side ramps, one to interface with the outer male connectors 17 of the mat 10 and one to interface with the female connectors 29. FIGS. 12-14B show different views of a male side ramp 50 having outer male ramp connectors 51. The male side ramp 50 has a top 53 and a bottom 55. The outer male ramp connectors 51 are the same in configuration as the outer male connectors 17 on the mat 10. The outer male ramp connectors 51 are designed to engage the recesses 31 of the female connectors 29 of the mat to terminate a particular edge. The side ramp taper is shown in FIGS. 14A and B, with FIG. 14A showing the sectional view including the outer male ramp connector 51, with FIG. 14B showing the sectional view reflecting the recess 52 between adjacent outer male ramp connectors 51. This cross sectional views of these two Figures illustrate a step 57, which is analogous to the step 21 associated with the outer male connectors 17.

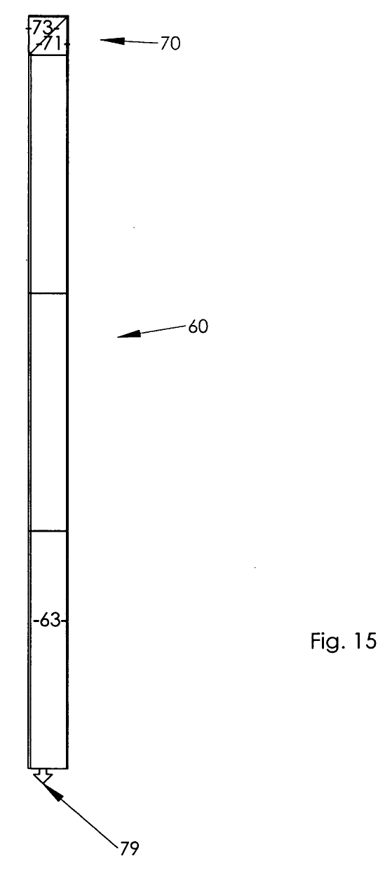

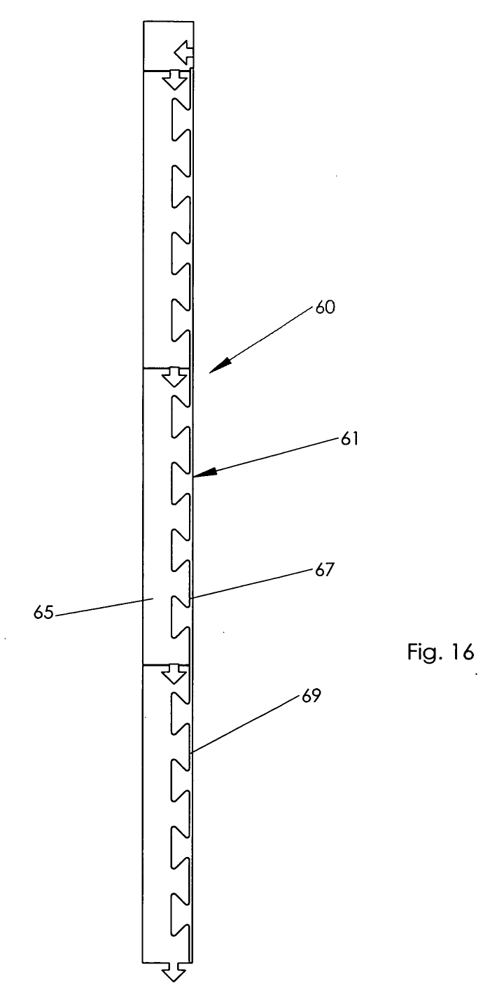

FIGS. 15 and 16 shows a female side ramp 60 with female ramp connectors 61. The female side ramps have a top 63 and a bottom 55. The female ramp connectors 61 are the same in configuration as the female collectors 29 on the mat 10. The female ramp connectors 61 are designed to receive the outer male connectors 17 of the mat to terminate a particular edge. The side ramp taper for the side ramp is the same as that shown in FIGS. 14A and 14B for the male side ramps. In addition, the female ramp connector 61 includes a step 69, which corresponds to the step 40 associated with the female connectors 29.

Referring back to FIGS. 12-14B, the male side ramp 50 can include a corner piece 70, which has two angled surfaces 71 and 73, one surface 71 matching the taper of the top 53, and the other surface 73 designed to match the taper of an adjacent side ramp linked to the corner piece 70.

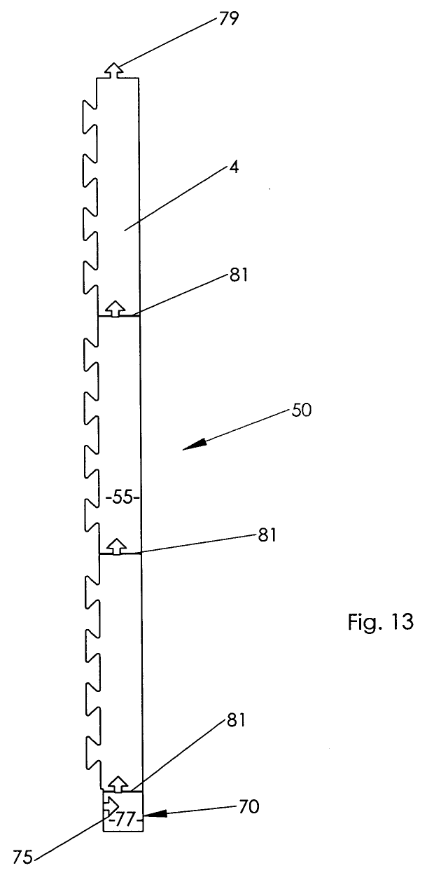

Referring to FIG. 13, the corner piece 70 has a recess 75 in a bottom 77. The other end of the side ramp 50 has an end male connector 79. If two side ramps are to be connected at 90 degree angles, the end male connector 79 of one corner piece 70 engages the recess 75 in the bottom 77 of another side ramp. FIGS. 15 and 16 show a corner piece 70 as found on the female side ramp mat 60. The end male connector 79 can also interface with recesses formed in the underside of the ramps 50 and 60 when connecting side ramps along their longitudinal axis as described below.

In an exemplary use of the side ramps 50 and 60 and referring back to FIG. 1, all of the sides 13, 15, 25, and 27 of the mat 10 can be terminated by using two male side ramps 50 and two female side ramps 60. The male side ramps 50 would go along sides 25 and 27, with the outer male ramp collectors 51 engaging the recesses 31 in the female connectors 29. The recess 75 in the corner piece 70 of the side ramp attached to side 27 would connect with the end male connector 79 of the male side ramp attached to side 25 of the mat 10. A similar connection arrangement would be made between the sides 13 and 15 of the mat 10 and two female side ramps 60. The mat 10 would then be surrounded by four side ramps, each being securely held in place due to the engagement of the connectors on the mat with the connectors on the side ramps.

The side ramps 50 and 60 are also designed to be variable in length to terminate mat sides of varying length. Referring to FIGS. 12 and 13 for the explanation of this feature, the male side ramp 50 has cut lines 81 at unit length intervals. Associated with each cut line 81 is a recess 83, which is complementary in shape to the end male connector 79. If a mat application leaves a side exposed that has a length of four unit lengths for termination, one three unit length side ramp can be employed in combination with a modified side ramp that is cut along a unit length line to leave a recess 83 on one end and an end male connector 79 on the other end, e.g., the unit length identified as “Y” in FIG. 13. In this use, the side ramps being linked together using the modified and shortened side ramp Y are aligned along the longitudinal axis of the side ramps. The recess 83 of the single unit length side ramp can receive the end male connector 79 of the three unit length side ramp, with the single unit length side ramp male end connector used to link to another side ramp at the corner of the mat. As an alternative, the side ramp that is to be cut to length could include the corner piece 70 if the side ramps to be connected meet at a corner of the mat.

It should also be understood that the corner piece 70 could be made optional and the one end of the side ramp would have a recess similar to recess 83 formed therein. In this mode, the side ramp would be strictly designed for connection with other side ramps along their respective longitudinal axis.

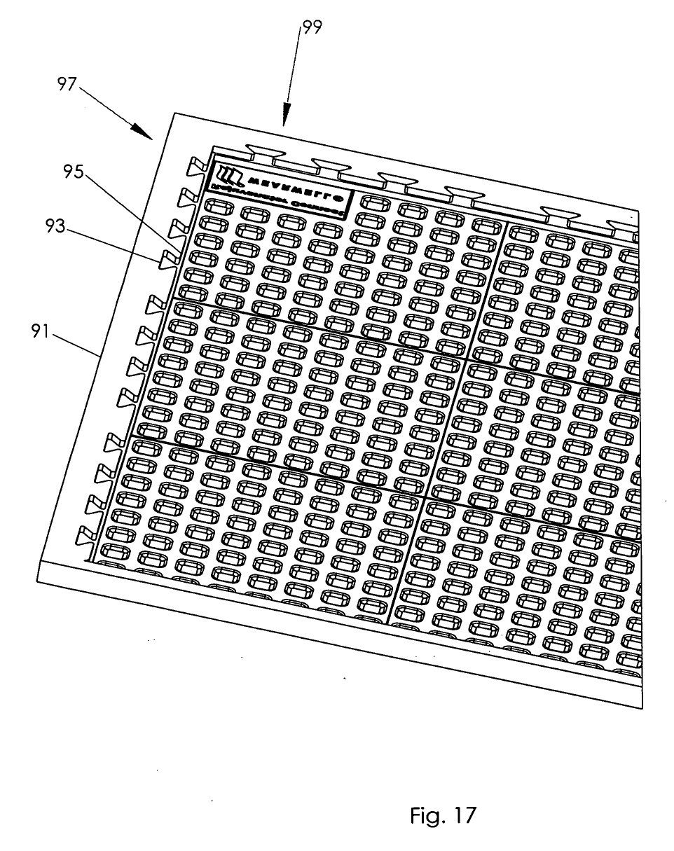

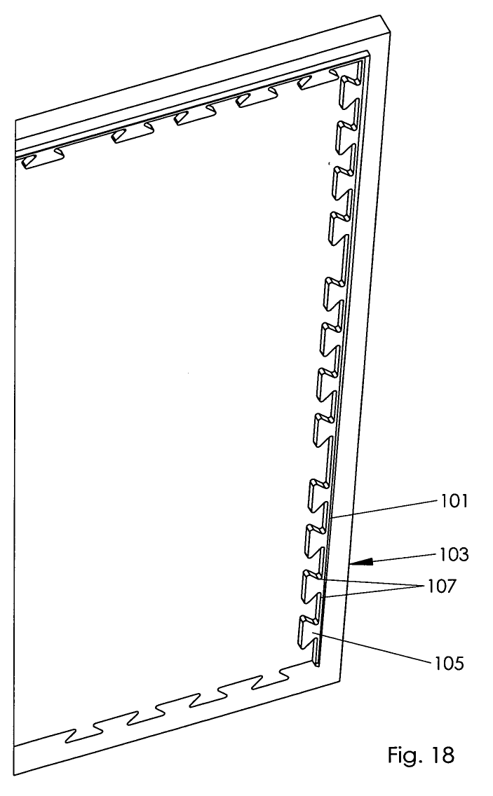

Another aspect of the invention is the method of making the mat and the mold used in the inventive method. In one mode, the method and mold that are used to make the inventive mat are similar to the method and mold normally used to make polyurethane foam mats. The inventive mold has a bottom mold half and a top mold half, the two halves together forming a volume, which would generally correspond to the size of the mat 10 in its final molded state. A portion of the two mold halves of the inventive mold are shown in FIGS. 17 and 18. Referring to FIG. 17, the bottom mold half 91 is configured with cavities 93 and a step 95 on two sides 97 and 99 to form the outer male connectors 17 found on sides 13 and 15 of the mat 10. FIG. 18 shows one side 101 of the upper or top mold half 103, which is configured with cavities 105 and a step 107 to form the female connectors 29 that are formed on sides 25 and 27 of the mat 10.

In an example of forming a polyurethane foam mat, the two part polyurethane composition is poured into the bottom mold half of the mold. The mold is preferably angled to such an extent that the poured liquid flows by gravity to the two sides 97 and 99 (the low sides) of the bottom mold half 91 configured to form the outer male connectors. The poured liquid also flows to the other two sides configured to form the female sides (the high sides) of the bottom half mold as a result of the natural creep characteristic of the polyurethane composition. Once the poured liquid has spread out over the bottom mold half, the mold is closed by lowering of the top mold half and the reaction is allowed to take place to form the polyurethane foam mat.

Two things occur during the molding process that are important in improving the connections of the mat. The poured liquid that flows to the sides 97 and 99 of the mold configured to form the outer male connectors meets resistance at the end of the cavities in the mold, thus slowing down the flow of the liquid material. Excess composition can overflow the cavity and seep out of the mold. However, the resistance to the flow of liquid material results in increase in density of the foam material along the periphery of the outer male connector, and this density increase makes the connectors stronger and less susceptible to breaking during use.

The high side of the mold is also modified with one or more venting holes in the top mold half. Referring again to FIG. 18, the upper surface of the cavities 105 in the top half mold are equipped with at least one venting hole, preferably at a corner of the cavity that forms the inner male connector 33. More preferably, there is a venting hole at each corner in the top half mold. The venting holes allows air and excess material to escape the mold and, at the same time, the corner portions of the inner male connector are formed with increased density as compared to a central portion of the inner male connectors. This increase in density at the corners where the venting holes are in the top half mold improves the connectivity of the mats when linked with adjacent mats.

While a preferred material for the inventive mat is a polyurethane foam, other polymeric materials that can be molded in a similar fashion as a polyurethane composition can be used. Also, while the mold is shown designed to produce the mat 10 of FIG. 1 with connectors along all four sides, other mold configurations could be used to form mats with a different number of sides containing connection capability. In addition, the mold could be configured to form the side ramps as well, including the use of the vent holes to form the female connectors in the side ramps. In addition, although the mat of FIG. 1 is shown with connectors along its entire edge, it is also possible that the connectors could be formed along only a portion of the side edge if a particular mat installation would dictate the need for such.

As such, an invention has been disclosed in terms of preferred embodiments thereof which fulfills each and every one of the objects of the present invention as set forth above and provides a new and improved molded mat, a method of making and a mold for toe piece for wakeboard bindings and its method of use.

Of course, various changes, modifications and alterations from the teachings of the present invention may be contemplated by those skilled in the art without departing from the intended spirit and scope thereof. It is intended that the present invention only be limited by the terms of the appended claims.

I claim:

1. A molded mat comprising:
a) a mat body having a peripheral edge;
b) at least one set of outer male connectors along at least a portion of the peripheral edge;
c) at least one set of female connectors along at least another portion of the peripheral edge;
wherein the portion of the peripheral edge includes a step, with each male connector extending from the step; and
wherein each female connector comprises a recess formed in an underside of the mat, adjacent recesses separated by an inner male connector, an end face of the inner male connector spaced from the peripheral edge of the mat body;
wherein the outer male connectors are adapted to engage recesses of female connectors of an adjacent mat and the recesses of each female connector are adapted to receive inner male connectors of an adjacent mat to link one or more adjacent mats together.

2. The mat of claim 1, wherein the mat has a square or rectangular shape wherein the outer male connectors are arranged along two sides of the mat, and the female connectors arranged along the remaining two sides.

3. The mat of claim 1, wherein the outer and inner male connectors have a trapezoidal shape, and the recesses of the female connectors have a corresponding trapezoidal shape.

4. The mat of claim 1, wherein a peripheral portion of each of the inner male connectors has a higher density than a central portion of each of the inner male connectors.

5. The mat of claim 2, wherein the mat along one side thereof has a length made up of a plurality of unit lengths, each unit length defined by a line extending perpendicular to the one side and across a width of the mat.

6. The mat of claim 5, wherein the mat has another side defining a width that is made of up of a plurality of unit widths, each unit width defined by a line extending perpendicular to the other side and across the length of the mat.

7. The mat of claim 5, wherein an underside of the mat has a groove that runs along each unit length line, the underside of the mat including a plurality of underside recesses positioned along each unit length line and respective unit length groove, wherein cutting the mat along the unit length line creates a mat of reduced length with underside female connectors along the unit length line, each underside female connector comprising one of the underside recesses along the cut unit length line and an underside inner male connector between adjacent underside recess, each underside inner male connector having an end face spaced from a cut edge of the mat, the underside female connectors formed along the unit length line adapted to link to outer male connectors of an adjacent mat.

8. The mat of claim 9, wherein an underside of the mat has a groove that runs along each unit length line and each unit width line, the underside of the mat including a first plurality of underside recesses along each unit length line and respective unit length groove and a second plurality of underside recesses along each unit width line and respective unit width groove, wherein cutting the mat along one of the unit length line or unit width line creates a mat of reduced length or width with underside female connectors, each underside female connector comprising one of the underside recesses along the cut unit length or unit width line and an underside inner male connector between adjacent underside recess, each underside inner male connector having an end face spaced from a cut edge of the mat to link, the underside female connectors created by the cut unit length or unit width line adapted to connect to outer male connectors of an adjacent mat.

9. A combination mat comprising the mat of claim 2, and at least first and second side ramp mats, the first side ramp mat further comprising a plurality of outer male ramp connectors adapted to engage female connectors on the mat, the first side ramp having a tapered cross section, with a thicker portion of the mat coinciding with the outer male ramp connectors, the second side ramp mat further comprising a plurality of female ramp connectors adapted to engage outer male connectors on the mat, the second side ramp having a tapered cross section, with a thicker portion of the mat coinciding with the female ramp connectors, one end of each of the first and second side ramps having a female corner end connector and the other end of each of the first and second side ramps having a male end connector, the male end connector of the first and second side ramps adapted to engage a female corner end connector on an adjacent first or second side ramp for linking side ramps that are each connected to a different side of the mat.

10. A combination mat comprising the mat of claim 6, and at least first and second side ramp mats, the first side ramp mat further comprising a plurality of outer male ramp connectors adapted to engage female connectors on the mat, the first side ramp having a tapered cross section, with a thicker portion of the mat coinciding with the outer male ramp connectors, the second side ramp mat further comprising a plurality of female ramp connectors adapted to engage outer male connectors on the mat, the second side ramp having a tapered cross section, with a thicker portion of the mat coinciding with the female ramp connectors, one end of each of the first and second side ramps having a female corner end connector and the other end of each of the first and second side ramps having a male end connector, the male end connector of the first and second side ramps adapted to engage a female corner end connector on an adjacent first or second side ramp for linking side ramps that are each connected to a different side of the mat, wherein each of the first and second side ramps has a ramp length made up of unit ramp lengths that correspond to either unit lengths or unit widths of the mat, each of the first and second side ramps having a ramp recess in an underside of the ramp at each unit ramp length, wherein cutting at the unit ramp length exposes the recess for connection to a male end connector of an axially aligned first or second side ramp.

11. The combination mat of claim 5, wherein the female corner end connector on each end of each of the first and second side ramps comprises a recess in an underside of the female corner end connector, an upper surface of the female corner end connector having one portion angled to match a taper of the side ramp having the female corner end connector as a part thereof, with the other portion angled to match a taper of an adjacent and perpendicularly attached side ramp.

12. A method of molding a mat comprising the steps of:
a) providing a mold comprising a bottom mold half and a top mold half, the bottom mold half having at least one outer male connector forming side, the at least one outer male connector forming side including a first step and a plurality of first recesses to receive a mat molding composition, the top mold half having at least one female connector forming side, the female connector forming side including a second step and a plurality of second recesses to receive the mat molding composition, the top mold half including at least one vent hole in communication with each second recess to allow air and excess mat molding composition to exit the top mold half during a molding process to increase a density of the mat molding composition to be formed in each second recess of the female connector that is in a vicinity of the at least one vent hole during the molding process; and
b) pouring the mat molding composition into the bottom mold half and covering the bottom mold half with the top mold half to mold the mat; and
c) removing the molded mat from the mold once the molding is complete.

13. The method of claim 12, wherein the mold bottom half has two sides forming outer male connectors and the mold top half has two sides forming female connectors.

14. The method of claim 12, wherein each of the first and second recesses are provided with a trapezoidal shape, and top mold half is provided with the vent hole near each outer corner of each trapezoidal shaped second recess.

15. A mold for making molded mats comprising a bottom mold half and a top mold half, the bottom mold half having at least one outer male connector forming side, the outer male connector forming side including a first step and a plurality of first recesses adapted to receive a mat molding composition, the top mold half having at least one female connector forming side, the female connector forming side including a second step and a plurality of second recesses, the second step and second recess adapted to receive the mat molding composition, the top mold half including at least one vent hole in communication with each second recess to allow air and excess foaming composition to exit the mold during a molding process.

16. The mold of claim 15, wherein each of the first and second recesses and the protrusions have a trapezoidal shape, the top mold half containing a pair of vent holes, each vent hole positioned in a respective outer corner of each of the trapezoidal shaped second recesses.

17. The mold of claim 15, wherein the mold bottom half has two sides forming outer male connectors and the mold top half has two sides forming female connectors.

18. A molded mat comprising:
a) a mat body having a square or rectangular shape;
b) outer male connectors along two sides of the mat body;
c) female connectors along two other sides of the mat body,
wherein the male connectors are adapted to connect to female connectors of an adjacent molded mat and the female connector are adapted to receive male connectors of an adjacent molded mat to link the two mats together;
wherein the mat along one side thereof has a length made up of a plurality of unit lengths, each unit length defined by a line extending perpendicular to the one side and across a width of the mat, with the mat having another side defining a width that is made of up of a plurality of unit widths, each unit width defined by a line extending perpendicular to the other side and across the length of the mat;
wherein an underside of the mat includes a first plurality of underside recesses along a respective unit length line and a second plurality of underside recesses along a respective unit width line, wherein cutting the mat along one of the unit length line or unit width line creates a mat of reduced length or width with underside female connectors, the underside female connectors created by the cut unit length or unit width line adapted to connect to outer male connectors of an adjacent mat.

19. The mat of claim 18, wherein the sides of the mat containing the outer male connectors includes a step, with each outer male connector extending from the step, and wherein the female connectors along the other sides of the mat further comprises a recess, adjacent female connectors separated by an inner male connector, an end face of each inner male connector spaced from an edge of the side of the mat to create a second step, each unit length line aligned in a first groove, with each unit width line aligned in a second groove, cutting along the first or second grooves forming the underside female connectors corresponding to the female connectors along the sides of the mat so that the underside female connectors created by cutting along the first or second grooves can connect to outer male connectors of an adjacent mat.

20. The mat of claim 1, wherein the mat is a polyurethane foam mat.

21. The method of claim 12, wherein the mat composition is a polyurethane foam mat composition.

22. The mat of claim 18, wherein the mat is a polyurethane foam mat.
